(19) United States
(12) Patent Application Publication
(10) Pub. No.: US 2012/0207113 A1
(43) Pub. Date: Aug. 16, 2012

(54) APPARATUS AND METHOD FOR TRANSMITTING AND RECEIVING MACHINE TO MACHINE DATA IN A WIRELESS COMMUNICATION SYSTEM

(75) Inventors: Sung-Hoon YOON, Yongin-si (KR); Young-Sung Kho, Seongnam-si (KR)

(73) Assignee: Samsung Electronics Co., Ltd., Suwon-si (KR)

(21) Appl. No.: 13/397,235

(22) Filed: Feb. 15, 2012

(30) Foreign Application Priority Data
Feb. 15, 2011 (KR) 10-2011-0013197

(51) Int. Cl. H04W 72/04

(52) U.S. Cl. 370/329

(57) ABSTRACT

An apparatus and method for transmitting and receiving Machine to Machine (M2M) data between a Base Station (BS) and a terminal in a wireless communication system are provided. The terminal receives a downlink Media Access Control (MAC) packet from a Base Station (BS), and obtains the M2M data by interpreting MAC layer control information included in the downlink MAC packet.

### PRIORITY

The present application claims priority under 35 U.S.C. §119(a) to Korean patent application Serial No. 10-2011-0013197, which was filed in the Korean Intellectual Property Office on Feb. 15, 2011, the entire content of which is incorporated herein by reference.

### BACKGROUND OF THE INVENTION

1. Field of the Invention

The present invention relates generally to a wireless communication system.

2. Description of the Related Art

FIG. 1 illustrates a Machine to Machine (M2M) structure in a wireless communication system according to 3rd Generation Partnership Project (3GPP) standards.

Referring to FIG. 1, the system includes M2M devices 110, a network 120, and an M2M platform 130. The M2M devices 110 include Machine Type Communication (MTC) devices. The network 120 includes bearer service/Short Message Service (SMS)/Internet protocol Multimedia Subsystem (IMS). The M2M platform 130 includes MTC servers, and interfaces with the bearer service/SMS/IMS network of the network 120 through a Public Land Mobile Network (PLMN)-MTC server interworking function.

M2M communication is applicable to the fields of telematics, goods management, navigation, smart metering (power, gas, water service, etc.), a remote sensing technology (river water level, bridge safety state sensing, etc.), mobile payment, etc. For example, when a smart meter collects metering data according to a purpose of smart metering (e.g., power, gas, water service, etc.), a data bearer should be setup up to the smart meter. Consequently, a huge signaling load is generated.

Additionally, a smart meter uses an Internet Protocol (IP) stack, increasing the cost of an M2M device.

Further, when many M2M devices send and receive a large amount of messages via the air through the network, an excessive signaling load occurs in the air and a large load is applied to the network, increasing the probability of network failure.

### SUMMARY OF THE INVENTION

The present invention is designed to substantially solve at least the above-described problems and/or disadvantages and to provide at least the advantages below.

Accordingly, an aspect of the present invention is to provide an apparatus and method for transmitting and receiving M2M communication data in a wireless communication system.

Another aspect of the present invention is to provide an apparatus and method for reducing a signaling load for M2M communication in a wireless communication system.

Another aspect of the present invention is to provide an apparatus and method for performing data transmission without an IP stack in a wireless communication system.

Another aspect of the present invention is to provide an apparatus and method for performing data transmission using a Media Access Control (MAC) Control Element (CE) in a wireless communication system.

In accordance with an aspect of the present invention, an operation method by a terminal in a wireless communication system is provided. The method includes receiving a downlink Media Access Control (MAC) packet from a Base Station (BS); and obtaining Machine to Machine (M2M) data by interpreting MAC layer control information included in the downlink MAC packet.

In accordance with another aspect of the present invention, an operation method by a BS in a wireless communication system is provided. The method includes receiving a downlink packet including Machine to Machine (M2M) data from a core network; extracting the M2M data from the downlink packet; generating Media Access Control (MAC) layer control information including the M2M data; generating a downlink MAC packet including the MAC layer control information; and transmitting the downlink MAC packet to a terminal.

In accordance with another aspect of the present invention, a terminal apparatus in a wireless communication system is provided. The apparatus includes a modem for receiving a downlink Media Access Control (MAC) packet from a Base Station (BS); and a controller for obtaining Machine to Machine (M2M) data by interpreting MAC layer control information included in the downlink MAC packet.

In accordance with another aspect of the present invention, a BS apparatus in a wireless communication system is provided. The apparatus includes a backhaul communication unit for receiving a downlink packet including Machine to Machine (M2M) data from a core network; a controller for extracting the M2M data from the downlink packet, generating Media Access Control (MAC) layer control information including the M2M data, and generating a downlink MAC packet including the MAC layer control information; and a modem for transmitting the downlink MAC packet to a terminal.

### BRIEF DESCRIPTION OF THE DRAWINGS

The above and other aspects, features, and advantages of certain embodiments of the present invention will become more apparent from the following detailed description when taken in conjunction with the accompanying drawings, in which:

FIG. 1 illustrates a conventional M2M communication in a wireless communication system;

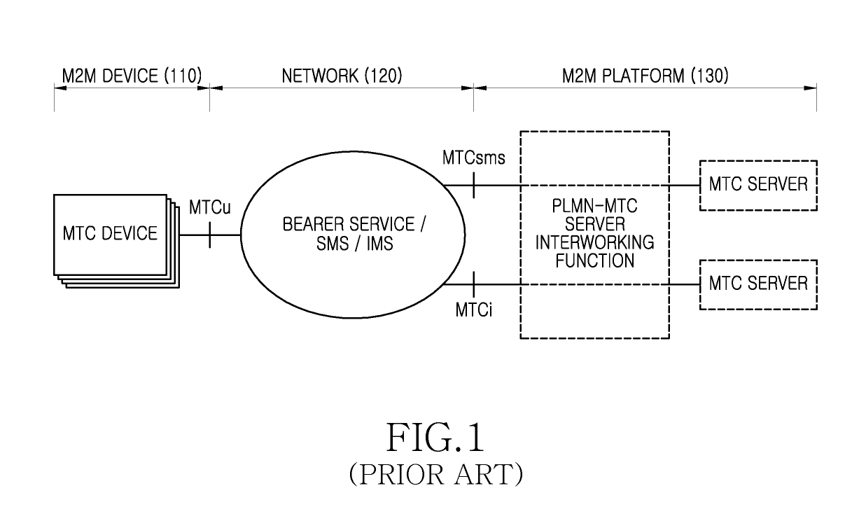

FIG. 2 illustrates a protocol connection structure in a wireless communication system according to an embodiment of the present invention;

FIG. 3 illustrates a packet structure for M2M data transmission in a wireless communication system according to an embodiment of the present invention;

FIG. 4 illustrates a packet MAC CE for M2M data transmission in a wireless communication system according to an embodiment of the present invention;

FIG. 5 illustrates a protocol structure by object in a wireless communication system according to an embodiment of the present invention;

FIG. 6 is a signal flow diagram illustrating M2M data transmission in a wireless communication system according to an embodiment of the present invention;

FIG. 7 is a flowchart illustrating an operation procedure of a terminal in a wireless communication system according to an embodiment of the present invention;

FIG. 8 is a flowchart illustrating an operation procedure of a BS in a wireless communication system according to an embodiment of the present invention;

FIG. 9 is a block diagram illustrating a terminal in a wireless communication system according to an embodiment of the present invention; and

FIG. 10 is a block diagram illustrating a BS in a wireless communication system according to an embodiment of the present invention.

Throughout the drawings, like reference numerals will be understood to refer to like parts, components, and structures.

### DETAILED DESCRIPTION OF EMBODIMENTS OF THE INVENTION

Various embodiments of the present invention will be described in detail herein below with reference to the accompanying drawings. In the following description, well-known functions or constructions are not described in detail to avoid obscuring the invention in unnecessary detail.

Although the following description of the embodiments of the present invention uses terms and names defined in the 3rd Generation Partnership Project (3GPP) Long Term Evolution (LTE) standards, the present invention is not limited by these terms and names, and is identically applicable to other similar systems.

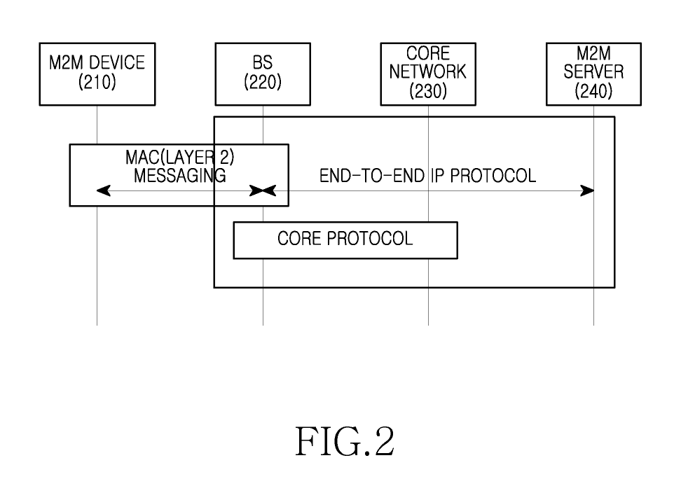

In a system according to an embodiment of the present invention, M2M data that is transmitted and received in an M2M device is processed in a MAC layer. That is, the M2M device does not include an IP stack, and transmits and receives data through a MAC layer message. Accordingly, connection of each protocol is generated as will be described below with reference to FIG. 2.

FIG. 2 illustrates a protocol connection structure in a wireless communication system according to an embodiment of the present invention.

Referring to FIG. 2, connection of an end-to-end IP protocol is established between a BS 220 and an M2M server 240, where no IP connection exists between an M2M device 210 and the BS 220. A MAC messaging connection is established between the M2M device 210 and the BS 220. Connection of a core protocol according to system standards is established between the BS 220 and a core network 230.

In a system according to an embodiment of the present invention, a MAC CE is used to forward data through a MAC layer message. The MAC CE, which is one of the fields included in a MAC packet, is generated and interpreted in a MAC layer of a BS and an M2M device. Accordingly, although there is no IP stack, the M2M device can generate and interpret the MAC CE.

For example, the MAC CE can be used for informing a buffer state, controlling a transmit power, or performing a Discontinued Reception (DRX) control.

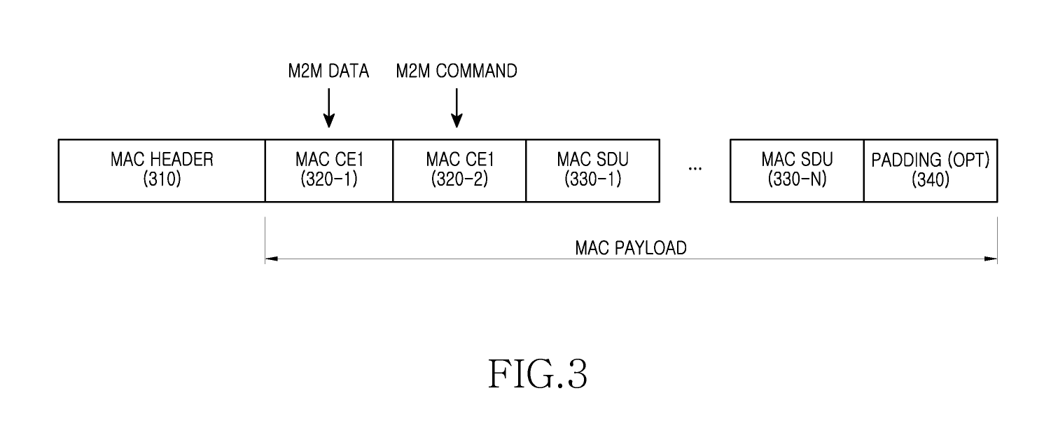

FIG. 3 illustrates a packet structure for M2M data transmission in a wireless communication system according to an embodiment of the present invention.

Referring to FIG. 3, a MAC packet includes a MAC header 310, a MAC CE 320, a MAC Service Data Unit (SDU) 330, and padding 340. The MAC CE 320 includes M2M data or M2M command.

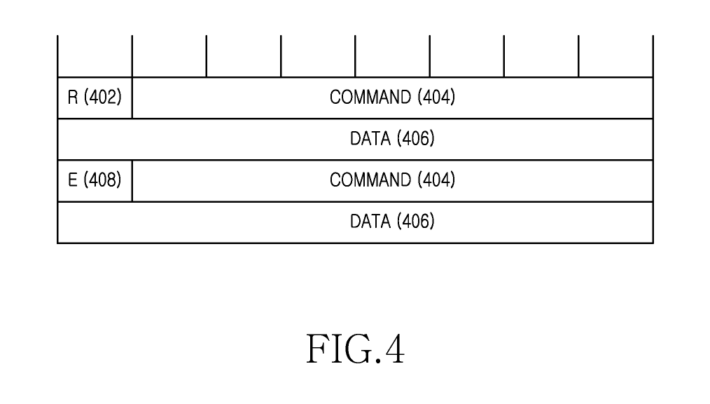

FIG. 4 illustrates a packet MAC CE for M2M data transmission in a wireless communication system according to an embodiment of the present invention.

Referring to FIG. 4, the MAC CE 320 includes at least one command field 404 and at least one data field 406. The command field 404 includes a command that an M2M device or an M2M server sends. A concrete value corresponding to each command substance can be decided through mutual engagement between the M2M device and the M2M server. For example, the command field 404 can have a length of 7 bits.

The data field 406 includes data related to a command included in the command field 404. For example, the data field 406 can have a length of 8 bits.

An extension indication field 408 indicates the existence or non-existence of an additional command. That is, when a plurality of command fields 404 are included in the MAC CE 320, the extension indication field 408 is set to indicate the existence of the command field 404 and the data field 406. The first command does not need the extension indication field 408, so the head of the first command 404 is occupied by a reserved field 402, which can always be set as ‘0’.

For example, when only one command is transmitted, the extension indication field 408 is set as ‘0’, and the subsequent one command field 404 and one data field 406 are each filled with ‘0’. However, when two or more commands are transmitted, the extension indication field 408 is set as ‘1’.

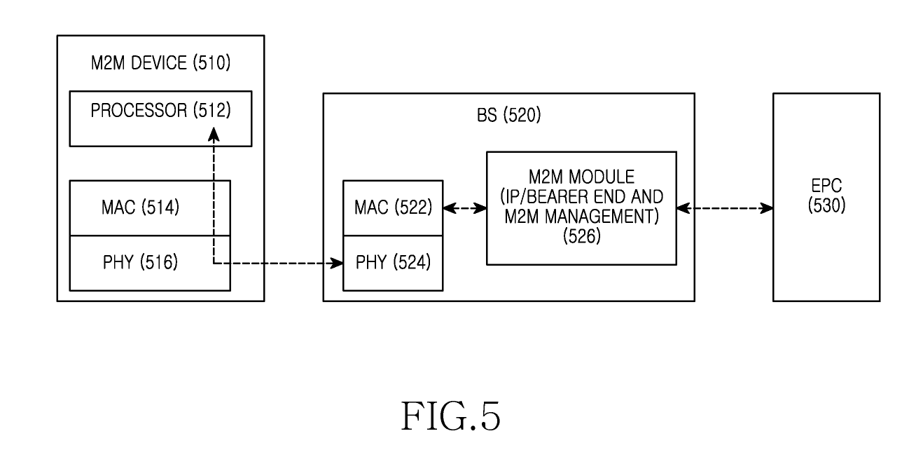

FIG. 5 illustrates a protocol structure by object in a wireless communication system according to an embodiment of the present invention.

Referring to FIG. 5, an M2M device 510 includes a processor 512, a MAC layer 514, and a PHYsical (PHY) layer 516. Data generated by the processor 512 is forwarded to the MAC layer 514, converted into a MAC CE in the MAC layer 514, and then transmitted to a BS 520 through the PHY layer 516. The data received from the BS 520 through the PHY layer 516 is interpreted in the MAC layer 514 and is forwarded to the processor 512.

The BS 520 includes a MAC layer 522, a PHY layer 524, and an M2M module 526 performing a role of IP/bearer end and a role of M2M management. To support communication with a general terminal, the BS 520 can include an upper layer of the MAC layer 522.

Data received from an Evolved Packet Core (EPC) 530 is forwarded to the MAC layer 522 by the M2M module 526, and is then transmitted to the M2M device 510 through the PHY layer 524. The data received from the M2M device 510 through the PHY layer 524 is interpreted in the MAC layer 522, forwarded to the M2M module 526, and transmitted to the EPC 530. Here, the EPC 530 is an object included in a core network of the system.

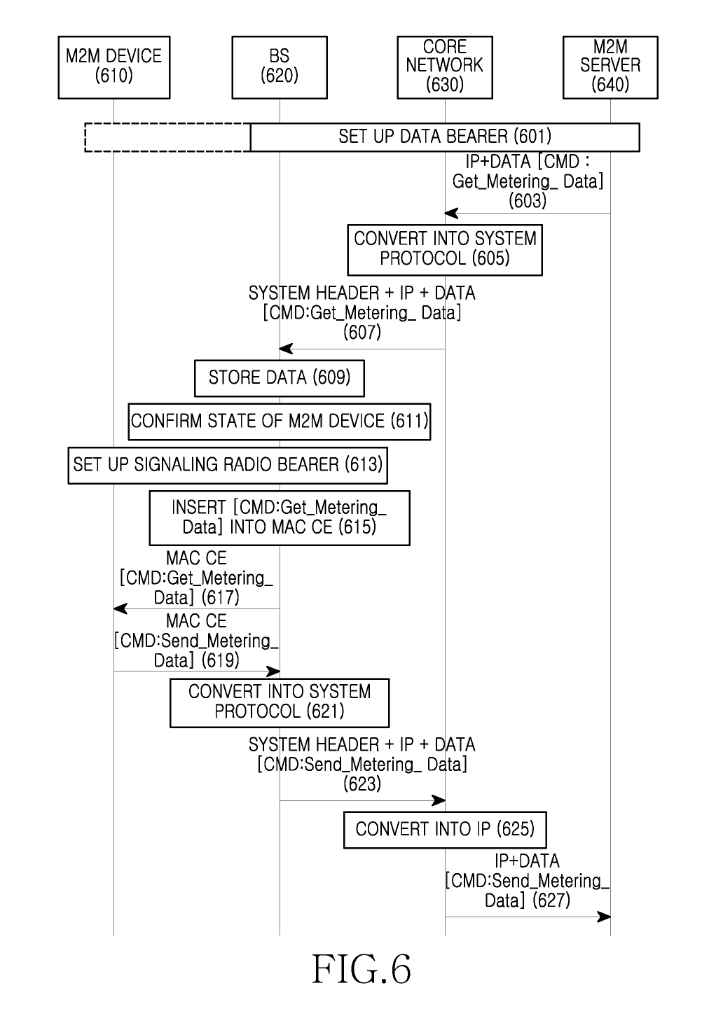

FIG. 6 is a signal flow diagram illustrating M2M data transmission in a wireless communication system according to an embodiment of the present invention.

Referring to FIG. 6, in step 601, a BS 620, a core network 630, and an M2M server 640 sets up a data bearer for an M2M device 610. The M2M device 610 does not take part in the setup of the data bearer. That is, the BS 620 ends the data bearer for the M2M device 610, for example, by processing a signaling message direction that the M2M device 610 will transmit and receive.

In step 603, the M2M server 640 determines to transmit M2M data to the M2M device 610, and transmits a packet including the M2M data to the core network 630. The packet, which is an IP packet, includes an IP header and the M2M data. For example, when the M2M device 610 is a smart meter, the M2M server 640 can send a command of requesting metering data.

In step 605, the core network 630 converts the IP packet into a form according to a system protocol. That is, the core network 630 generates a downlink packet according to a system protocol that includes the IP packet as a payload. For example, the core network 630 adds a system header. The system header can be a General Packet Radio Services (GPRS) Tunneling Protocol (GTP) header.

In step 607, the core network 630 transmits the downlink packet including the system header, the IP header, and the M2M data, to the BS 620 through the data bearer.

In step 609, the BS 620 extracts the M2M data from the downlink packet and stores the M2M data. In step 611, the BS 620 confirms a state of the M2M device 610. That is, the BS 620 determines if a signaling bearer with the M2M device 610 has been setup. Herein, tit is assumed that the signaling bearer between the BS 620 and the M2M device 610 has not been setup. Accordingly, in step 613, the BS 620 and the M2M device 610 set up a signaling radio bearer.

In step 615, the BS 620 inserts the M2M data stored in step 609 into a MAC CE. That is, the BS 620 generates a downlink MAC packet that includes the M2M data in the MAC CE. The downlink MAC packet includes a MAC header and at least one MAC CE including the M2M data, and may optionally include a MAC SDU.

In step 617, the BS 620 transmits the downlink MAC packet including the MAC header and the at least one MAC CE, to the M2M device 610 through the signaling bearer. Here, the MAC CE includes at least one command field and at least one data field. When a plurality of command fields are included in the MAC CE, the MAC CE can include an extension indication field. For example, the MAC CE can be constructed as illustrated in FIG. 4.

In step 619, the M2M device 610 obtaining the M2M data through the MAC CE transmits the M2M data using the MAC CE. That is, because the M2M data received in step 617 is a command requesting metering data, the M2M device 610 generates metering data representing a metering result of a corresponding object, and generates an uplink MAC packet including the metering data, i.e., the M2M data in the MAC CE. The uplink MAC packet includes a MAC header and at least one MAC CE including the M2M data, and may optionally include a MAC SDU.

In step 621, the BS 620 obtaining the uplink MAC packet including the M2M data in the MAC CE converts the uplink MAC packet into a form according to a system protocol. That is, the BS 620 extracts the M2M data included in the MAC CE, generates an IP packet including the M2M data as a payload, and then adds a system header according to a system protocol to the IP packet. The system header can be a GTP header.

In step 623, the BS 620 transmits an uplink packet including the system header, the IP header, and the M2M data, to the core network 630 through the data bearer.

In step 625, the core network 630 converts the uplink packet into an IP packet. For example, the core network 630 generates the IP packet including the M2M data by eliminating the system header. In step 627, the core network 630 transmits the IP header and the IP packet including the M2M data, to the M2M server 640.

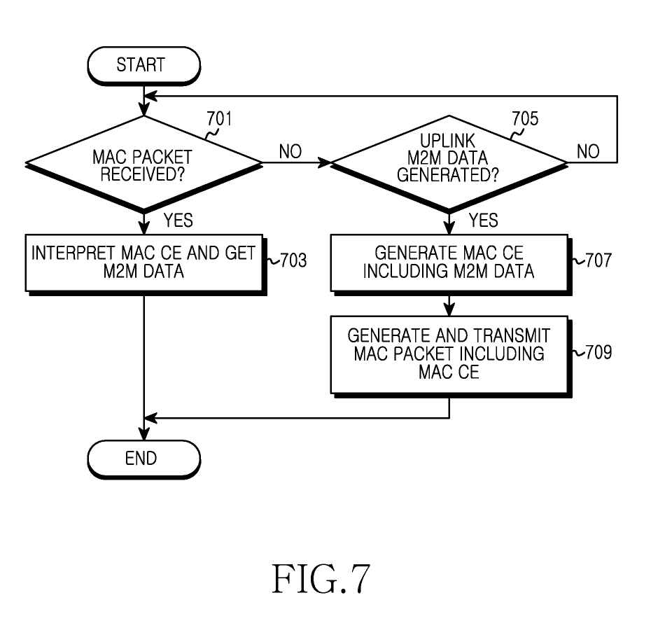

FIG. 7 illustrates an operation procedure of a terminal in a wireless communication system according to an embodiment of the present invention.

Referring to FIG. 7, in step 701, the terminal determines if a downlink MAC packet is received through a signaling bearer. Accordingly, although not illustrated in FIG. 7, prior to the reception of the downlink MAC packet, the terminal can perform a signaling bearer setup procedure with a BS. The downlink MAC packet includes a MAC header and at least one MAC CE including M2M data, and may not include a MAC SDU.

When the downlink MAC packet is received, the terminal obtains the M2M data by interpreting the at least one MAC CE included in the MAC packet in step 703. That is, the terminal obtains the M2M data by interpreting MAC layer control information included in the MAC packet. The M2M data is transmitted by an M2M server corresponding to the terminal. For example, when the terminal is a smart meter, the M2M data can include a request for metering data.

Herein, the MAC CE includes at least one command field and at least one data field. When a plurality of command fields are included in the MAC CE, the MAC CE can include an extension indication field. For example, the MAC CE can be constructed as illustrated in FIG. 4.

When the downlink MAC packet is not received, the terminal determines if uplink M2M data is generated in step 705. For example, when the terminal receives a request for transmission of specific data from the M2M server, the terminal can generate uplink M2M data. Alternatively, when the terminal is designed to periodically transmit M2M data according to a service characteristic, the terminal can generate uplink M2M data every period.

When the uplink M2M data is generated, the terminal generates a MAC CE including the M2M data in step 707. That is, the terminal generates MAC layer control information including the M2M data.

In step 709, the terminal generates an uplink MAC packet including the MAC CE including the M2M data, and transmits the uplink MAC packet to the BS. The uplink MAC packet includes a MAC header and at least one MAC CE including the M2M data, and may optionally include a MAC SDU.

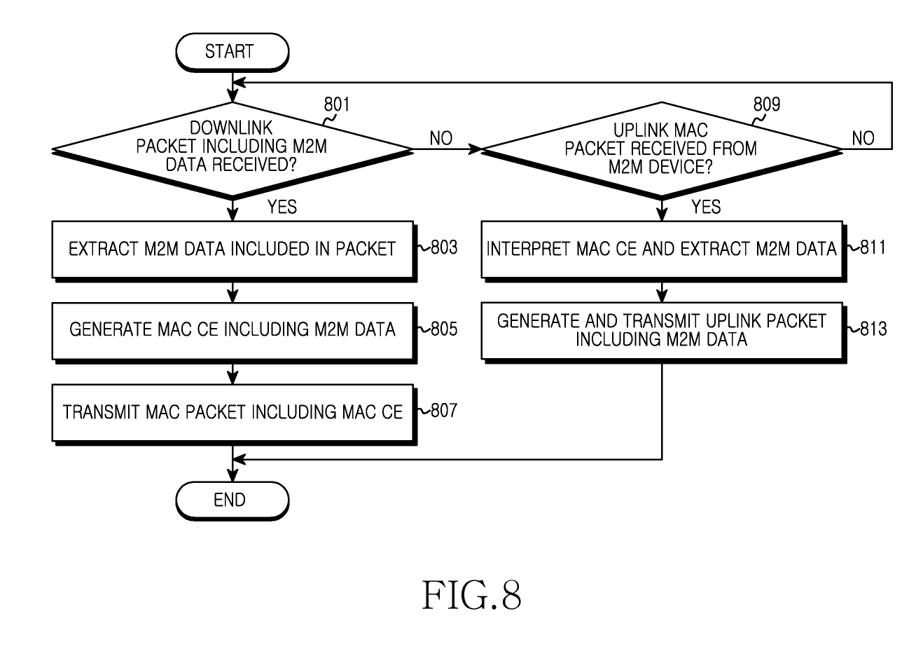

FIG. 8 illustrates an operation procedure of a BS in a wireless communication system according to an embodiment of the present invention.

Referring to FIG. 8, in step 801, the BS determines if a downlink packet including M2M data is received. That is, if a downlink packet according to a system protocol having an M2M device as a destination is received from an upper node, the BS determines if the M2M data is included in the downlink packet, by identifying if a sender of the downlink packet is an M2M server. The downlink packet can include a system header, an IP header, and the M2M data. The downlink packet is received through a data bearer. Accordingly, although not illustrated in FIG. 8, prior to the reception of the downlink packet, the BS can perform a data bearer setup procedure for the M2M device with a core network. At this time, the BS can end the data bearer by processing a signaling message direct that the M2M device will transmit and receive.

When the downlink packet including the M2M data is received, the BS extracts the M2M data included in the downlink packet in step 803. That is, the BS eliminates a system header and an IP header in the downlink packet, separating the M2M data from the downlink packet.

After extracting the M2M data, the BS generates a MAC CE including the M2M data in step 805. That is, the BS generates MAC layer control information including the M2M data. Here, the MAC CE includes at least one command field and at least one data field. When a plurality of command fields are included in the MAC CE, the MAC CE can include an extension indication field. For example, the MAC CE can be constructed as illustrated in FIG. 4.

After generating the MAC CE, the BS generates a downlink MAC packet including the MAC CE, and transmits the downlink MAC packet to the M2M device in step 807. The downlink MAC packet includes a MAC header and at least one MAC CE including the M2M data, and may optionally include a MAC SDU. The downlink MAC packet is transmitted through a signaling bearer. Accordingly, although not illustrated in FIG. 8, prior to the transmission of the downlink MAC packet, the BS can perform a signaling bearer setup procedure with the M2M device.

When the downlink packet is not received in step 801, the BS determines if an uplink MAC packet is received from the M2M device in step 809. The uplink MAC packet is received through a signaling bearer, and includes a MAC header and at least one MAC CE including the M2M data and may not include a MAC SDU.

When the uplink MAC packet is received, the BS extracts M2M data by interpreting at least one MAC CE included in the MAC packet in step 811. That is, the BS extracts the M2M data by interpreting MAC layer control information included in the MAC packet. For example, when the M2M device is a smart meter, the M2M data can include metering data representing the metering result of a corresponding object.

After obtaining the M2M data, in step 813, the BS generates an uplink packet including the M2M data and transmits the uplink packet to the upper node. That is, the BS generates an IP packet including the M2M data as a payload, converts the IP packet into an uplink packet according to a system protocol, and then transmits the uplink packet to the upper node through the data bearer. For example, the BS can convert the IP packet into the uplink packet according to the system protocol by adding a system header according to a system protocol to the IP packet. The system header can be a GTP header.

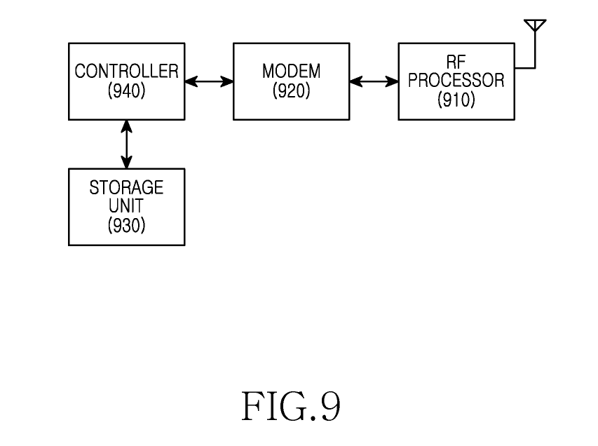

FIG. 9 illustrates a terminal in a wireless communication system according to an embodiment of the present invention.

Referring to FIG. 9, the terminal includes a Radio Frequency (RF) processor 910, a modem 920, a storage unit 930, and a controller 940.

The RF processor 910 performs functions for transmitting and receiving signals through a wireless channel, e.g., signal band conversion, amplification, etc. That is, the RF processor 910 up converts a baseband signal provided from the modem 920 into an RF band signal and then transmits the RF band signal through an antenna, and down converts an RF band signal received through the antenna into a baseband signal. For example, the RF processor 910 can include an amplifier, a mixer, an oscillator, a Digital to Analog Converter (DAC), an Analog to Digital Converter (ADC), etc.

The modem 920 performs a function of conversion between a baseband signal and a bit stream according to the physical layer standard of the system. For example, when utilizing an Orthogonal Frequency Division Multiplexing (OFDM) scheme, at data transmission, the modem 920 generates complex symbols by encoding and modulating a transmission bit stream, maps the complex symbols to subcarriers, and then constructs OFDM symbols through Inverse Fast Fourier Transform (IFFT) operation and Cyclic Prefix (CP) insertion. At data reception, the modem 920 divides a baseband signal provided from the RF processor 910 in the unit of OFDM symbol, restores signals mapped to subcarriers through Fast Fourier Transform (FFT) operation, and restores a reception bit stream through demodulation and decoding.

The storage unit 930 stores data of a basic program for an operation of the terminal, an application program, etc. Particularly, the storage unit 930 stores an application program for the terminal to serve as an M2M device. The storage unit 930 provides stored data according to a request of the controller 940.

Although not illustrated in FIG. 9, the terminal can further include a block serving as an M2M device. For example, when the terminal is a smart meter, the terminal can further include a block for metering.

The controller 940 controls a general function of the terminal. For example, the controller 940 controls a function as an M2M device. Also, the controller 940 generates transmission M2M data and provides the M2M data to the modem 920, and interprets reception M2M data provided from the modem 920. That is, the controller 940 controls to transmit and receive the M2M data using MAC layer control information included in a MAC packet.

Specifically, during M2M data reception, when a downlink MAC packet is received through a signaling bearer, the controller 940 obtains M2M data by interpreting MAC layer control information included in the MAC packet, e.g., at least one MAC CE.

Further, during M2M data transmission, when uplink M2M data is generated, the controller 940 generates MAC layer control information including the M2M data, e.g., a MAC CE. For example, when the controller 940 receives a request for transmission of specific data from the M2M server, the controller 940 can generate uplink M2M data. Alternatively, when the terminal should periodically transmit M2M data according to a service characteristic, the controller 940 can generate uplink M2M data every period. The controller 940 generates an uplink MAC packet including the MAC CE including the M2M data, and transmits the uplink MAC packet to a BS through the modem 920 and the RF processor 910. The uplink MAC packet includes a MAC header and at least one MAC CE including the M2M data, and may optionally include a MAC SDU.

The MAC packet including the MAC layer control information including the M2M data is transmitted and received through a signaling bearer. Accordingly, prior to the transmission and reception of the MAC packet, the controller 940 can perform a signaling bearer setup procedure with the BS.

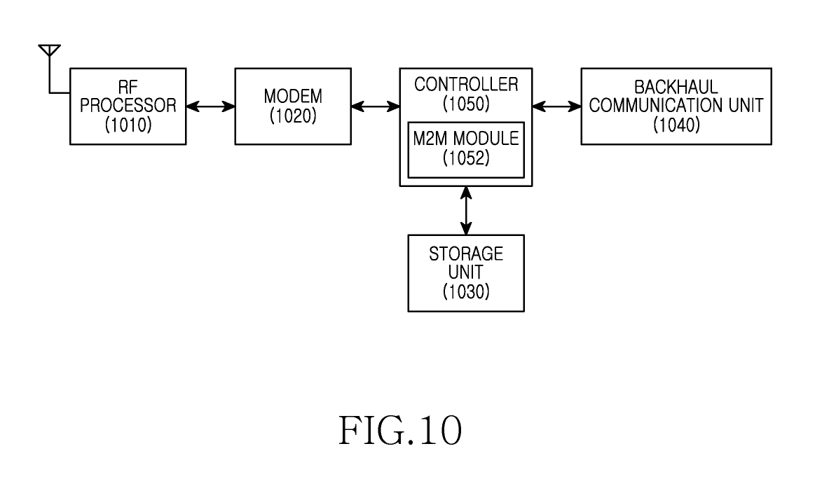

FIG. 10 illustrates a BS in a wireless communication system according to an embodiment of the present invention.

Referring to FIG. 10, the BS includes an RF processor 1010, a modem 1020, a storage unit 1030, a backhaul communication unit 1040, and a controller 1050.

The RF processor 1010 performs functions for transmitting and receiving signals through a wireless channel, such as signal band conversion, amplification, etc. That is, the RF processor 1010 up converts a baseband signal provided from the modem 1020 into an RF band signal and then transmits the RF band signal through an antenna, and down converts an RF band signal received through the antenna into a baseband signal. For example, the RF processor 1010 can include an amplifier, a mixer, an oscillator, a DAC, an ADC, etc.

The modem 1020 performs a function of conversion between a baseband signal and a bit stream according to the physical layer standard of the system. For example, when utilizing an OFDM scheme, at data transmission, the modem 1020 generates complex symbols by encoding and modulating a transmission bit stream, maps the complex symbols to subcarriers, and then constructs OFDM symbols through IFFT operation and CP insertion. Further, at data reception, the modem 1020 divides a baseband signal provided from the RF processor 1010 in the unit of OFDM symbol, restores signals mapped to subcarriers through FFT operation, and restores a reception bit stream through demodulation and decoding.

The storage unit 1030 stores data of a basic program for operation of the BS, an application program, system setup information, etc. Particularly, the storage unit 1030 stores information on terminals accessing the BS, e.g., information on which terminal is an M2M device and provides stored data according to a request of the controller 1050.

The backhaul communication unit 1040 provides an interface for the BS to perform communication with an upper node belonging to a core network. That is, the backhaul communication unit 1040 converts a bit stream transmitted from the BS to the upper node into a physical signal, and converts a physical signal received from the upper node into a bit stream.

The controller 1050 controls a general function of the BS. For example, the controller 1050 generates a transmission traffic packet and message, provides the generated packet and message to the modem 1020, and interprets a reception traffic packet and message provided from the modem 1020. Particularly, an M2M module 1052 within the controller 1050 controls transmission and reception of M2M data with an M2M device, using MAC layer control information included in a MAC packet. In FIG. 10, the M2M module 1052 is included in the controller 1050; however, according to another embodiment of the present invention, the M2M module 1052 can be constructed as a separate block.

For M2M data transmission to the M2M device, the M2M module 1052 determines if a downlink packet including M2M data is received from a core network. That is, when a downlink packet according to a system protocol having an M2M device as a destination is received from an upper node, the M2M module 1052 determines if M2M data is included by identifying if a sender of the downlink packet is an M2M server. The downlink packet can include a system header, an IP header, and the M2M data.

When the downlink packet including the M2M data is received, the M2M module 1052 extracts the M2M data included in the downlink packet, and generates MAC layer control information including the M2M data, e.g., a MAC CE, generates a downlink MAC packet including the MAC CE, and transmits the downlink MAC packet to the M2M device. The downlink MAC packet includes a MAC header and at least one MAC CE including the M2M data, and may optionally include a MAC SDU.

For M2M data reception from the M2M device, the M2M module 1052 determines if an uplink MAC packet is received from the M2M device through a signaling bearer. The uplink MAC packet includes a MAC header and at least one MAC CE including M2M data, and may optionally include a MAC SDU.

When the uplink MAC packet is received, the M2M module 1052 obtains the M2M data by interpreting MAC layer control information included in the MAC packet, e.g., at least one MAC CE, generates an IP packet including the M2M data as a payload, converts the IP packet into an uplink packet according to a system protocol, and controls the modem 1020 and the RF processor 1010 to transmit the uplink packet to an upper node through a data bearer. For example, the M2M module 1052 can convert the IP packet into the uplink packet according to the system protocol by adding a system header according to a system protocol to the IP packet. The system header can be a GTP header.

The MAC packet including the MAC layer control information including the M2M data is transmitted and received through a signaling bearer. Accordingly, prior to the transmission and reception of the MAC packet, the controller 1050 can perform a signaling bearer setup procedure with the M2M device. The packet according to the system protocol including the M2M data is transmitted through a data bearer. Accordingly, the controller 1050 can perform a data bearer setup procedure for the M2M device with a core network. At this time, the controller 1050 can end the data bearer in the BS by processing a signaling message direction that the M2M device will transmit and receive.

As described above, embodiments of the present invention can reduce a wireless signaling load by transmitting and receiving M2M data using a MAC CE including MAC layer control information in a wireless communication system.

While the present invention has been shown and described with reference to certain embodiments thereof, it will be understood by those skilled in the art that various changes in form and details may be made therein without departing from the spirit and scope of the present invention as defined by the appended claims and their equivalents.

What is claimed is:

1. A method of operation by a terminal in a wireless communication system, the method comprising:
receiving a downlink Media Access Control (MAC) packet from a Base Station (BS); and
obtaining Machine to Machine (M2M) data by interpreting MAC layer control information included in the downlink MAC packet.

2. The method of claim 1, wherein the downlink MAC packet is received through a signaling bearer.

3. The method of claim 1, further comprising performing a signaling bearer setup procedure with the BS.

4. The method of claim 1, wherein the MAC layer control information includes a MAC Control Element (CE) generated and interpreted in a MAC layer of the terminal and the BS.

5. The method of claim 4, wherein the MAC CE includes at least one of a command field, a data field, and an extension indication field indicating that a plurality of commands are included in the MAC CE.

6. The method of claim 1, further comprising:
generating M2M data to be transmitted to an M2M server;
generating MAC layer control information including the M2M data;
generating an uplink MAC packet including the MAC layer control information; and
transmitting the uplink MAC packet to the BS.

7. A method of operation by a Base Station (BS) in a wireless communication system, the method comprising:
receiving a downlink packet including Machine to Machine (M2M) data from a core network;
extracting the M2M data from the downlink packet;
generating Media Access Control (MAC) layer control information including the M2M data;
generating a downlink MAC packet including the MAC layer control information; and
transmitting the downlink MAC packet to a terminal.

8. The method of claim 7, wherein the downlink packet includes a system header, an Internet Protocol (IP) header, and the M2M data.

9. The method of claim 8, wherein the system header includes a General Packet Radio Services (GPRS) Tunneling Protocol (GTP) header.

10. The method of claim 7, wherein the downlink MAC packet is received through a signaling bearer.

11. The method of claim 7, further comprising performing a signaling bearer setup procedure with the terminal.

12. The method of claim 7, wherein the downlink packet is received through a data bearer for the terminal.

13. The method of claim 12, further comprising ending the data bearer in the BS by processing a signaling message direction that the terminal will transmit and receive.

14. The method of claim 7, wherein the MAC layer control information includes a MAC Control Element (CE) generated and interpreted in a MAC layer of the terminal and the BS.

15. The method of claim 14, wherein the MAC CE includes at least one of a command field, a data field, and an extension indication field indicating that a plurality of commands are included in the MAC CE.

16. The method of claim 7, further comprising:
receiving an uplink MAC packet including MAC layer control information including M2M data from the terminal;
extracting the M2M data from the uplink MAC packet;
generating an uplink packet including the M2M data; and
transmitting the uplink packet to the core network through a data bearer.

17. The method of claim 16, wherein generating the uplink packet comprises:
generating an IP packet including the M2M data as a payload; and
converting the IP packet into an uplink packet according to a system protocol.

18. The method of claim 17, wherein converting the IP packet into the uplink packet according to the system protocol comprises adding a system header to the IP packet according to a system protocol.

19. The method of claim 18, wherein the system header includes a General Packet Radio Services (GPRS) Tunneling Protocol (GTP) header.

20. An apparatus for a terminal in a wireless communication system, the apparatus comprising:
a modem for receiving a downlink Media Access Control (MAC) packet from a Base Station (BS); and
a controller for obtaining Machine to Machine (M2M) data by interpreting MAC layer control information included in the downlink MAC packet.

21. The apparatus of claim 20, wherein the downlink MAC packet is received through a signaling bearer.

22. The apparatus of claim 20, wherein the controller performs a signaling bearer setup procedure with the BS.

23. The apparatus of claim 20, wherein the MAC layer control information comprises a MAC Control Element (CE) generated and interpreted in a MAC layer of the terminal and the BS.

24. The apparatus of claim 22, wherein the MAC CE comprises at least one of:
a command field;
a data field; and
an extension indication field indicating that a plurality of commands are included in the MAC CE.

25. The apparatus of claim 20, wherein, when M2M data to be transmitted to an M2M server is generated, the controller generates MAC layer control information including the M2M data, and generates an uplink MAC packet including the MAC layer control information, and
wherein the modem transmits the uplink MAC packet to the BS.

26. An apparatus for a Base Station (BS) in a wireless communication system, the apparatus comprising:
a backhaul communication unit for receiving a downlink packet including Machine to Machine (M2M) data from a core network;
a controller for extracting the M2M data from the downlink packet, generating Media Access Control (MAC) layer control information including the M2M data, and generating a downlink MAC packet including the MAC layer control information; and
a modem for transmitting the downlink MAC packet to a terminal.

27. The apparatus of claim 26, wherein the downlink packet comprises:
a system header;
an Internet Protocol (IP) header; and
the M2M data.

28. The apparatus of claim 27, wherein the system header comprises a General Packet Radio Services (GPRS) Tunneling Protocol (GTP) header.

29. The apparatus of claim 26, wherein the downlink MAC packet is received through a signaling bearer.

30. The apparatus of claim 26, wherein the controller performs a signaling bearer setup procedure with the terminal.

31. The apparatus of claim 26, wherein the downlink packet is received through a data bearer for the terminal.

32. The apparatus of claim 31, wherein the controller ends the data bearer in the BS by processing a signaling message direction that the terminal will transmit and receive.

33. The apparatus of claim 26, wherein the MAC layer control information comprises a MAC Control Element (CE) generated and interpreted in a MAC layer of the terminal and the BS.

34. The apparatus of claim 33, wherein the MAC CE comprises at least one of:
a command field;
a data field, and
an extension indication field indicating that a plurality of commands are included in the MAC CE.

35. The apparatus of claim 26, wherein the modem receives an uplink MAC packet including MAC layer control information including M2M data from the terminal,
wherein the controller extracts the M2M data from the uplink MAC packet, and generates an uplink packet including the M2M data, and
wherein the backhaul communication unit transmits the uplink packet to the core network through a data bearer.

36. The apparatus of claim 35, wherein the controller generates an IP packet including the M2M data as a payload, and converts the IP packet into the uplink packet according to a system protocol.

37. The apparatus of claim 36, wherein the controller converts the IP packet into the uplink packet according to the system protocol by adding a system header according to the system protocol to the IP packet.

38. The apparatus of claim 36, wherein the system header comprises a General Packet Radio Services (GPRS) Tunneling Protocol (GTP) header.
